(19) United States
(12) Patent Application Publication
(10) Pub. No.: US 2011/0225563 A1
(43) Pub. Date: Sep. 15, 2011

(54) SYSTEM FOR ACCESSING AND SHARING USER DEFINED CONTENTS AND METHOD OF THE SAME

(75) Inventors: Ki Heon KIM, Daejeon (KR); Won Young KIM, Daejeon (KR); Won Hyuk Choi, Daejeon (KR); Kyong I KU, Seoul (KR)

(73) Assignee: Electronics and Telecommuncations Research Institute, Daejeon (KR)

(21) Appl. No.: 13/048,437

(22) Filed: Mar. 15, 2011

(30) Foreign Application Priority Data
Mar. 15, 2010 (KR) 10-2010-0022811
Mar. 15, 2011 (KR) 10-2011-0022717

(51) Int. Cl. G06F 9/445; G06F 9/44

(52) U.S. Cl. 717/106; 717/178

(57) ABSTRACT

A system for accessing and sharing content having a user-defined format is provided. The system for accessing and sharing content having a user-defined format includes: a user-defined content (UDC) developing device providing a UDC usage program and a UDC sharing program supporting accessing and sharing of UDC having a user-defined format; a Web server uploading the UDC usage program such that the UDC usage program can be downloaded, and installing the UDC sharing program in a server; and a user terminal downloading the UDC usage program from the Web server to access UDC having the user-defined format, and sharing the UDC with a different user terminal through the UDC sharing program installed in the Web server.

### BACKGROUND OF THE INVENTION

1. Field of the Invention

The present invention relates to a system for accessing and sharing content having a user-defined format capable of allowing programs for supporting the function of accessing and sharing user-defined content having a user-defined format to be easily developed and distributed, and an operation method thereof.

2. Description of the Related Art

The advancement of Web services has enabled users to easily register user-created content (UCC) having various formats, such as a music file format, a video file format, a document file format, or the like, to portals and selectively download and access the registered UCC. However, just as video sites support only videos, existing Web sites are limited to using only particular content formats, and users must access the corresponding Web sites to use them.

Also, at present, content having formats arbitrarily defined by users (i.e., user-defined content), rather than formats supported by Web sites, cannot be used, and it is difficult for users to register or add an accessing and sharing function to a desired Web site.

### SUMMARY OF THE INVENTION

An aspect of the present invention provides a system for accessing and sharing content capable of supporting a working environment in which users can easily manage and access user-defined content (UDC) having a required format and a sharing environment in which users can share the corresponding UDC, and an operation method thereof.

According to an aspect of the present invention, there is provided a system for accessing and sharing content having a user-defined format, including: a user-defined content (UDC) developing device providing a UDC usage program and a UDC sharing program supporting accessing and sharing of UDC having a user-defined format; a Web server uploading the UDC usage program such that the UDC usage program can be downloaded, and installing the UDC sharing program in a server; and a user terminal downloading the UDC usage program from the Web server to access UDC having the user-defined format, and sharing the UDC with a different user terminal through the UDC sharing program installed in the Web server.

The UDC developing device may include: a UDC format defining unit generating an extensible markup language (XML) file including information regarding the user-defined format; a program generation unit generating the UDC usage program and the UDC sharing program by using the XML file; and a program providing unit uploading the UDC usage program to the Web server and installing the UDC sharing program in the Web server.

The program generation unit may include: a source code generation unit generating a source code of the UDC usage program and the UDC sharing program by using the XML file; and an installation file generation unit generating an installation file of the UDC usage program and the UDC sharing program by using the source code.

The Web server may include: a UDC usage program management unit registering and managing the UDC usage program and performing an operation of downloading the UDC usage program; a UDC sharing program execution unit performing an operation of uploading and downloading the UDC by using the UDC sharing program; and a server storage unit storing files and data related to the UDC usage program and the UDC sharing program, and the UDC.

The user terminal may include: a UDC usage program downloading the UDC sharing program registered to the Web server to support an access to the UDC having the user-defined format and performing an operation of uploading and downloading the UDC; and a terminal storage unit storing files and data related to the UDC sharing program, and the UDC.

According to another aspect of the present invention, there is provided a user-defined content (UDC) developing device including: a UDC format defining unit generating an extensible markup language (XML) file having information regarding the UDC format; a program generation unit generating a UDC usage program and a UDC sharing program supporting accessing and sharing of the UDC having the user-defined format by using the XML file; and a program providing unit uploading the UDC usage program to a Web server such that at least one user terminal can download the UDC usage program, and installing the UDC sharing program in the Web server such that at least one user terminal can share the UDC having the user-defined format.

The program generation unit may include: a source code generation unit generating a source code of the UDC usage program and the UDC sharing program by using the XML file; and an installation file generation unit generating an installation file of the UDC usage program and the UDC sharing program by using the source code.

According to another aspect of the present invention, there is provided a method for operating a system for accessing and sharing content having a user-defined format, including: generating an extensible markup language (XML) file having information regarding the format of user-defined content (UDC); generating a source code of a UDC usage program and a UDC sharing program by using the XML file and generating an installation file of the UDC usage program and the UDC sharing program by using the source code; uploading the UDC usage program to a Web server such that a user terminal can download the UDC usage program; and installing the UDC sharing program in the Web server such that UDC uploaded from the user terminal can be shared through the UDC sharing program.

The method may further include: installing, by a different user terminal, the UDC sharing program in the Web server in order to share the UDC uploaded from the user terminal through the UDC sharing program.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a system for accessing and sharing user-defined content (UDC) according to an exemplary embodiment of the present invention; and

FIG. 2 is a flow chart illustrating the process of a method for operating a system for accessing and sharing UDC according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

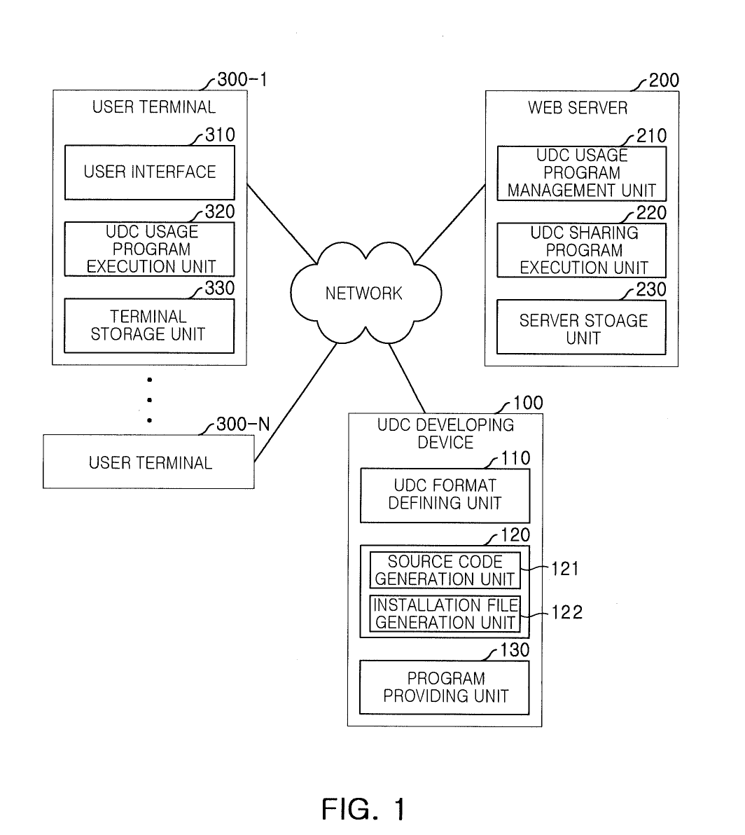

FIG. 1 is a schematic block diagram of a system for accessing and sharing user-defined content (UDC) according to an exemplary embodiment of the present invention.

With reference to FIG. 1, the system for accessing and sharing UDC according to an exemplary embodiment of the present invention includes a UDC developing device 100, a Web server 200, and at least one user terminal 300-1 to 300-N.

The UDC developing device 100, which may include a UDC format defining unit 110, a program generation unit 120, a program providing unit 130, and the like, serves to generate and distribute a UDC usage program and a UDC sharing program for accessing and sharing UDC having a user-defined format.

The format of the UDC may be determined by a type of content (e.g., video, photos, music, text, or the like) included in the UDC. The UDC usage program has a function of accessing content having the corresponding format of the UDC and a function of uploading the UDC to the UDC sharing program. The UDC sharing program has a function of uploading and downloading the UDC, so that several user terminals 300-1 to 300-N can share the same UDC. These programs may be generated in the form of a single package so as to be provided.

When the user-defined format of the UDC required by the user is determined, the UDC format defining unit 110 generates an extensible markup language (XML) file.

The program generation unit 120 includes a source code generation unit 121 generating a source code of the UDC usage program and the UDC sharing program by using the XML file and an installation file generation unit 122 generating an installation file of the UDC usage program and the UDC sharing program by using the source code. The program generation unit 120 generates the UDC usage program and the UDC sharing program for accessing and sharing the UDC having a user-defined format, and provides the same.

The program providing unit 130 registers the UDC usage program with the Web server 200 so that the user terminals 300-1 to 300-N can search for and download the UDC usage program required by a user, and installs the UDC sharing program in the Web server 200 so that the user terminals 300-1 to 300-N can share the same UDC through the UDC sharing program.

The Web server 200 serves to provide the UDC usage program having a format required by the user to the user terminals 300-1 to 300-N, respectively, or allows the user terminals 300-1 to 300-N to share the same UDC through the UDC sharing program. The Web server 200 may include a UDC usage program management unit 210, a UDC sharing program execution unit 220, a server storage unit 230, and the like.

The UDC usage program management unit 210 registers and manages the UDC usage program provided by the UDC developing device 100, and supports searching of the UDC usage program. When a particular user terminal 300-1 requests downloading of the UDC usage program, the UDC usage program management unit 210 downloads the corresponding UDC usage program to the corresponding user terminal 300-1.

The UDC sharing program execution unit 200 installs and executes the UDC sharing program provided by the UDC developing device 100 to store the UDC uploaded by the user terminals 300-1 to 300-N in the server storage unit 230 or download particular UDC to the user terminals 300-1 to 300-N which request sharing of the corresponding UDC.

The server storage unit 230 stores various files and data related to the UDC usage program and the UDC sharing program and the UDC to be shared by the user terminals 300-1 to 300-N.

The user terminals 300-1 to 300-N allow users to perform the operation of accessing and sharing the UDC, rather than on a Web site. Each of the user terminals 300-1 to 300-N may include a user interface unit 310, a UDC usage program execution unit 320, a terminal storage unit 330, and the like. Various electronic devices such as a smartphone, a tablet device, a notebook computer, a desktop computer, or the like, having a communication function may be employed as the user terminals 300-1 to 300-N.

The user interface unit 310 includes an input device such as a keypad, a mouse, or the like, detecting various user inputs in real time and providing information accordingly, and an output device such as a monitor, a speaker, or the like, providing information about an operational situation of the UDC usage program execution unit 310 in real time. The user interface unit 310 supports various input and output operations for the operation of accessing and sharing the UDC.

The UDC usage program execution unit 320 accesses the Web server 200 according to a user's request in order to download a UDC usage program corresponding to the format required by the user. Thus, the user can create UDC having his or her desired format by using the downloaded UDC usage program.

Also, upon completion of the creation of the UDC, when the user requests sharing of the UDC, the UDC usage program execution unit 320 may upload the corresponding UDC to the Web server 200 to allow other user terminals 300-2 to 300-N to download and share the UDC. Of course, the opposite case is available. Namely, the UDC usage program execution unit 320 may support a user's operation of searching and downloading the UDC to display UDC created by other user terminals 300-2 to 300-N.

The terminal storage unit 330 stores various files and data related to the UDC usage program, and the UDC to be shared by the user terminals 300-1 to 300-N.

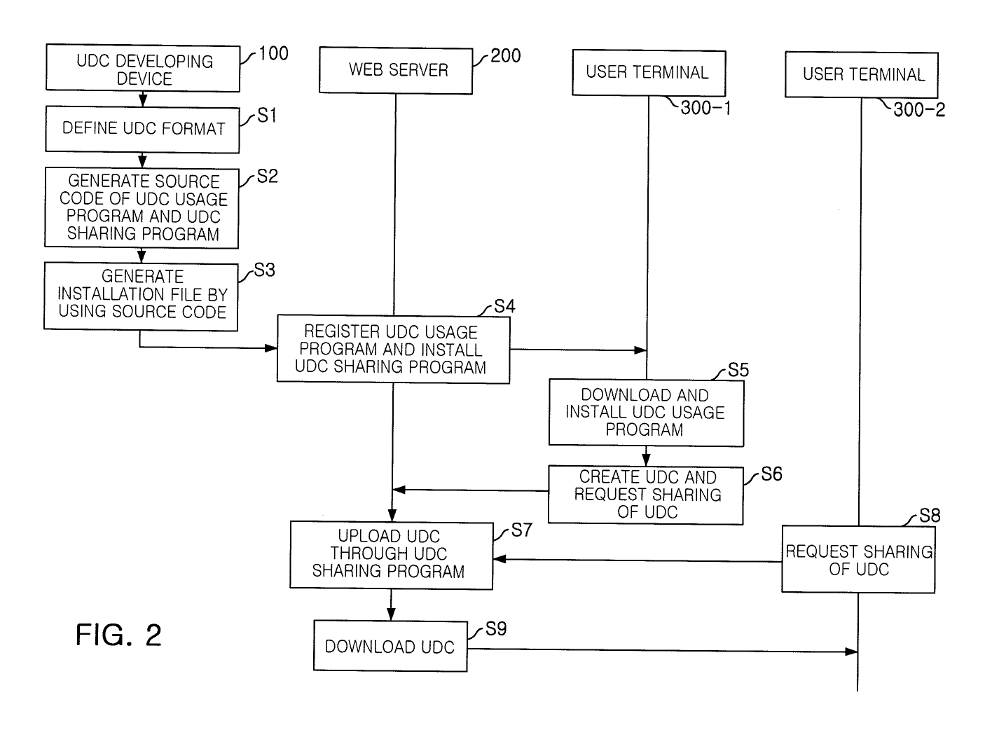

FIG. 2 is a flow chart illustrating the process of a method for operating a system for accessing and sharing UDC according to an exemplary embodiment of the present invention.

First, the UDC developing device 100 defines the UDC format according to a user request, and generates an XML file having information of the defined format of the UDC (step S1).

The UDC developing device 100 generates a source code of the UDC usage program and the UDC sharing program supporting accessing and sharing of the UDC having the user-defined format by using the XML file (step S2).

The UDC developing device 100 compiles the source code of the UDC usage program and the UDC sharing program to generate an installation file of the UDC usage program and the UDC sharing program (step S3).

The UDC developing device 100 uploads the UDC usage program to the Web server 200 to allow the user terminals 300-1 to 300-N to download it and installs the UDC sharing program in the Web server 200 to allow the user terminals 300-1 to 300-N to share the created UDC by using the UDC usage program (step S4).

In this manner, when the distribution of the UDC usage program and the UDC sharing program supporting accessing and sharing of the UDC having the user-defined format is completed, the users can access and share the UDC on their terminals through the following processes.

Namely, when a particular user terminal (e.g., 300-1) accesses the Web server to request downloading of a particular UDC usage program according to a user request, the Web server 200 performs an operation of downloading the UDC usage program in response, and the corresponding user terminal 300-1 installs the UDC usage program therein (step S5).

Then, the user can create UDC by using the UDC usage program installed in the user terminal 300-1 (step S6).

When the user has completed the creation of the UDC and requests sharing of the UDC, the UDC usage program installed in the user terminal 300-1 uploads the corresponding UDC to the UDC sharing program of the Web server 200 (step S7).

In this state, when one (e.g., 300-2) of the remaining user terminals 300-2 to 300-N requests sharing of the UDC which has been uploaded by the user terminal 300-1 (step S8), the UDC sharing program of the Web server 200 downloads the UDC, which has been requested to be shared, to the corresponding user terminal 300-2 (step S9).

Accordingly, the UDC created by the user terminal 300-1 can be shared by the different user terminal 300-2.

As set forth above, in the system for accessing and sharing content having a user-defined format and an operation method thereof according to exemplary embodiments of the invention, since a UDC usage program and a UDC sharing program allowing users to access and share UDC are developed by the UDC developing device and the UDC usage program is downloaded to a user terminal through a Web server, the users can access and share UDC via their terminals, rather than through a Web site.

In addition, since the UDC usage program and the UDC sharing program are registered to and installed in the Web server, the function of accessing and sharing UDC having a new format can be registered and added to a Web site.

Also, since the UDC developing device is proposed and programs are developed and distributed by the UDC developing device in a centralized manner, programs for supporting the function of accessing and sharing UDC having a user-defined format can be easily developed and distributed, and a repeated development of programs having the same function by several developers can be prevented.

While the present invention has been shown and described in connection with the exemplary embodiments, it will be apparent to those skilled in the art that modifications and variations can be made without departing from the spirit and scope of the invention as defined by the appended claims.

What is claimed is:

1. A system for accessing and sharing content having a user-defined format, the system comprising:
a user-defined content (UDC) developing device providing a UDC usage program and a UDC sharing program supporting accessing and sharing of UDC having a user-defined format;
a Web server uploading the UDC usage program such that the UDC usage program can be downloaded, and installing the UDC sharing program in a server; and
a user terminal downloading the UDC usage program from the Web server to access UDC having the user-defined format, and sharing the UDC with a different user terminal through the UDC sharing program installed in the Web server.

2. The system of claim 1, wherein the UDC developing device comprises:
a UDC format defining unit generating an extensible markup language (XML) file including information regarding the user-defined format;
a program generation unit generating the UDC usage program and the UDC sharing program by using the XML file; and
a program providing unit uploading the UDC usage program to the Web server and installing the UDC sharing program in the Web server.

3. The system of claim 2, wherein the program generation unit comprises:
a source code generation unit generating a source code of the UDC usage program and the UDC sharing program by using the XML file; and
an installation file generation unit generating an installation file of the UDC usage program and the UDC sharing program by using the source code.

4. The system of claim 2, wherein the Web server comprises:
a UDC usage program management unit registering and managing the UDC usage program and performing an operation of downloading the UDC usage program;
a UDC sharing program execution unit performing an operation of uploading and downloading the UDC by using the UDC sharing program; and
a server storage unit storing files and data related to the UDC usage program and the UDC sharing program, and the UDC.

5. The system of claim 1, wherein the user terminal comprises:
a UDC usage program downloading the UDC sharing program registered to the Web server to support an access to the UDC having the user-defined format and performing an operation of uploading and downloading the UDC; and
a terminal storage unit storing files and data related to the UDC sharing program, and the UDC.

6. A user-defined content (UDC) developing device comprising:
a UDC format defining unit generating an extensible markup language (XML) file having information regarding the UDC format;
a program generation unit generating a UDC usage program and a UDC sharing program supporting accessing and sharing of the UDC having the user-defined format by using the XML file; and
a program providing unit uploading the UDC usage program to a Web server such that at least one user terminal can download the UDC usage program, and installing the UDC sharing program in the Web server such that at least one user terminal can share the UDC having the user-defined format.

7. The device of claim 6, wherein the program generation unit comprises:
a source code generation unit generating a source code of the UDC usage program and the UDC sharing program by using the XML file; and
an installation file generation unit generating an installation file of the UDC usage program and the UDC sharing program by using the source code.

8. A method for operating a system for accessing and sharing contents having a user-defined format, the method comprising:
generating an extensible markup language (XML) file having information regarding the format of user-defined content (UDC);
generating a source code of a UDC usage program and a UDC sharing program by using the XML file and generating an installation file of the UDC usage program and the UDC sharing program by using the source code;
uploading the UDC usage program to a Web server such that a user terminal can download the UDC usage program; and
installing the UDC sharing program in the Web server such that UDC uploaded from the user terminal can be shared through the UDC sharing program.

9. The method of claim 8, further comprising:
installing, by a different user terminal, the UDC sharing program in the Web server in order to share the UDC uploaded from the user terminal through the UDC sharing program.
